(19) United States
(12) Patent Application Publication
(10) Pub. No.: US 2008/0114629 A1
(43) Pub. Date: May 15, 2008

(54) System for matching users and transportation providers

(75) Inventor: Dmitry Yurievich Pavlov, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/595,115

(22) Filed: Nov. 9, 2006

(51) Int. Cl. G06Q 10/00

(52) U.S. Cl. 705/7; 705/1

(57) ABSTRACT

A system for matching one or more users and a transportation provider. The system may include identifying a first user, identifying a second user, identifying a transportation provider and matching the first user, the second user and the transportation provider.

### TECHNICAL FIELD

The present embodiments relate generally to a system for sharing transportation, and more particularly, but not exclusively, to matching a user to one or more other users and then matching the group of users to a transportation provider.

### BACKGROUND

In some major metropolitan areas the airport that serves the area may be located a significant distance from a city center, or other destination point. Travelers arriving at these airports may have few transportation options taking them from the airport to a final destination. Some metropolitan areas may have public transportation taking travelers from the airport. Public transportation may be affordable; however, it also may be slow, as the public transportation may make many stops en route to the destination. Another transportation option may be a taxi cab, which may take a traveler directly to their destination. However, taxi cabs may be undesirable to some because they may be expensive, particularly when the airport is located a significant distance from the destination.

Some airports may have shuttle services that may transport several travelers to the destination. The shuttle services may take several travelers from the airport to the city center, dropping each traveler off at their precise destination. The shuttle service may determine which travelers and how many travelers may share a particular shuttle. The shuttle services may be less expensive than a taxicab and may be faster and more convenient than public transportation; however, the shuttle service may still suffer from being inconvenient and slow. The travelers may have little or no control over the traveling with a shuttle service. The convenience of the shuttle service for a particular traveler may be left solely to the discretion of the transportation provider.

### SUMMARY

A system for matching one or more users and a transportation provider may include: a memory, an interface, and a processor. The memory may be able to store information about a transportation provider, a first user and a second user. The interface may be operatively connected to the memory and may allow interaction between the first user, the second user and the transportation provider. The processor may be operatively connected to the memory and the interface to identify a first user, a second user, a transportation provider for matching the first user, the second user and the transportation provider.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the preferred embodiments.

### BRIEF DESCRIPTION OF THE DRAWINGS

Non-limiting and non-exhaustive embodiments are described with reference to the following drawings. In the drawings, like reference numerals may refer to like parts throughout the various figures unless otherwise specified.

FIG. 1 is a block diagram providing a general overview of a system for matching one or more users and a transportation provider.

FIG. 2 is a block diagram providing a simplified view of a network environment implementing a system for matching one or more users and a transportation provider.

FIG. 3 is a block diagram providing an example of the workflow of the systems of FIG. 1 and FIG. 2 or other systems for matching a first user to a second user and then matching both users to a transportation provider.

FIG. 4 is a flowchart illustrating basic operations of the systems of FIG. 1 and FIG. 2 or other systems for matching a first user to a second user and then matching the users to a transportation provider.

FIG. 5 is a flowchart illustrating steps that may be taken by a user in the systems of FIG. 1 and FIG. 2 or other systems for matching a first user to a second user and then matching both users to a transportation provider.

FIG. 6 is a flowchart illustrating steps that may be taken by a transportation provider in a system for matching one or more users to a transportation provider.

FIG. 7 is a flowchart illustrating operations of rating a user and rating a transportation provider that may be used in a system for matching a first user to a second user and then matching both users to a transportation provider.

### DETAILED DESCRIPTION

A system, and method, generally referred to as a system, relate to matching one or more users and a transportation provider to each other, and more particularly, but not exclusively, matching a user to one or more other users and then matching the matched users a transportation provider, such as a taxi cab provider.

The principles described herein may be embodied in many different forms. The system may allow a user to share transportation with one or more users. The system may incorporate a system for rating users that may provide users with information regarding the desirability of sharing transportation with a particular user. The system may also incorporate a system for rating transportation providers that may provide users with information regarding the desirability of being matched with a particular transportation provider. The system may allow transportation providers to submit bids for each user they are matched with.

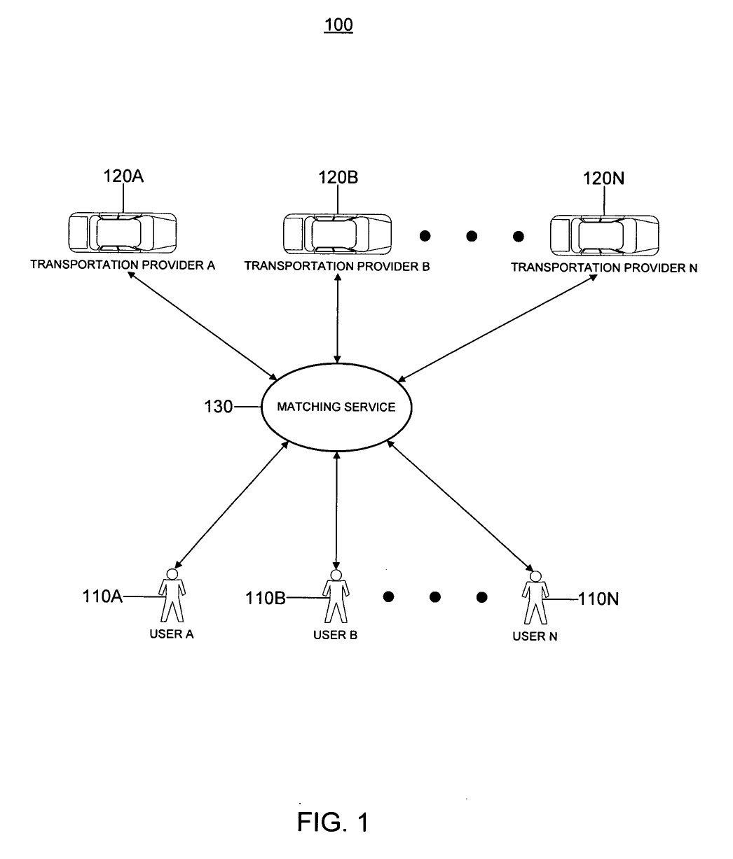

FIG. 1 provides a general overview of a system 100 for matching one or more users and a transportation provider. The system 100 may include one or more users 110A-N, a matching service 130, and one or more transportation providers 120A-N, such as taxi cab providers.

In the system 100, the users 110A-N may interact individually or together with the matching service 130, such as in person or via a web application. The web application may include a web browser or other application such as any application capable of displaying web content. The application may be implemented with a processor such as a personal computer, personal digital assistant, mobile phone, or any other machine capable of implementing a web application. The transportation providers 120A-N may also interact individually with the matching service 130, such as via a web application or in person. The transportation providers 120A-N may interact with the matching service 130 via a web based application. The matching service 130 may communicate data to the users 110A-N and the transportation providers 120A-N over a network.

In operation, the user A 110A may communicate a request to the matching service 130 to be matched with one of the users 110B-N. Thereafter, the users 110A-N may be matched with a transportation providers 120A-N. Alternatively or in addition, the user A 110A may be matched directly to a transportation provider 120A-N without first being matched to another user 110B-N. A second user 110B-N may later be matched to the user A 110A and the transportation provider 120A. The users 110A-N may be matched to the transportation provider 120A-N by using one or more criteria, such as a transportation provider 120A-N that provides transportation from origin x to destination y, at a date/time z. The matching service 130 may coordinate matching the user A 110A with one or more of the users 110B-N and matching the user A 110A with one of the transportation providers 120A-N. The matching service 130 may make the availability of user A 110A to share transportation known to the other users 110B-N.

The user B 110B, may become aware of the user A 110A availability, such as through searching user availability via the web application. The matching service 130 may only display the user A 110A as available if there are transportation providers 120A-N presently available to transport the user A 110A and the user B 110B from origin x to destination y at date/time z. User B 110B may communicate to the matching service 130 a request to share transportation with the user A 110A from origin x to destination y (or some destination near or on the way to y) at date/time z. The matching service 130 may communicate the transportation share request of user B 110B to the user A 110A. The user A 110A may either accept or decline the user B 110B transportation share request and communicate their decision to the matching service 130. The user A 110A decision may be based on several factors, including, any information known about the user B 110B and the proximity of the user B 110B destination to the user A 110A destination or route.

The user A 110A may input a set distance from their route that they may be willing to share transportation to. Thus, if the destination of the user B 110B is further from the user A 110A route than the distance set by the user A 110A, then the matching service 130 may not allow the user B 110B to request to share transportation with the user A 110A, or may not display the user A 110A as an available user to the user B 110B.

The matching service 130 may communicate the user A decision to the user B 110B. If the user A 110A accepts the user B 110B transportation share request, the matching service 130 may match the user A 110A and the user B 110B to one of the transportation providers 120A-N. The system 100 may require the user A 110A and the user B 110B to both approve of the matched transportation provider 120A-N. If the user A 110A or the user B 110B does not approve of the transportation provider 120A-N, the matching service 130 may attempt to match the users 110A-B to a different transportation provider 120A-N.

The match may be based on one or more of several factors, including the preferences identified by the user A 110A and/or the user B 110B and/or the transportation providers 120A-N, a route bid price specified by the transportation providers 120A-N, the availability of the transportation providers 120A-N, or generally any factor that may relate to matching the users 110A-N to the transportation providers 120A-N. The route bid price may be the price at which the transportation provider 120A-N is willing to transport users 110A-N from an origin x to a destination y at date/time z. Alternatively, the route bid price may be a set fare identified by the transportation provider 120A-N.

The users 110A-N and the transportation providers 120A-N may each have their own set of preferences which may be used to assist in matching the users 110A-N and transportation providers 120A-N. For the users 110A-N, these preferences may include the characteristics of users 110A-N they may prefer to share transportation with, the maximum number of users 110A-N they may desire to share transportation with, their preferences regarding characteristics of transportation providers 120A-N they may prefer to be transported by, such as the cost of the transportation provider 120A-N, the size of the transportation provider's transportation 120A-N, the generally hygiene or cleanliness of the transportation provider 120A-N, and generally any information that may assist in matching the users 110A-N to other users 110A-N and/or transportation providers 120A-N.

The transportation providers 120A-N may identify preferences that relate to the characteristics of users 110A-N they may prefer to provide transportation to, the maximum number of users 110A-N they may desire to provide transportation to, a general geographic area where they may prefer to pick up users 110A-N, a general geographic area where they may prefer to drop off users 110A-N, a day of the week or time of day range they prefer to transport users 110A-N during, and generally any information that may assist in matching the transportation providers 120A-N to users 110A-N.

The user A 110A and the user B 110B may only be matched to transportation providers 120A-N who have available transportation. The transportation providers 120A-N may be responsible for notifying the matching service 130 of which routes they may have transportation available for. The matching service 130 may provide a system that may allow the transportation providers to specify which origins, destinations and times they have transportation available for. The matching service 130 may provide a map that the transportation providers 120A-N may use to identify the zones where they have transportation available to or from. The transportation providers 120A-N may be responsible for updating the matching service 130 with their availability. If the transportation providers 120A-N indicate they have availability for a given origin, destination, and date/time, they may be held responsible to provide transportation for any users 110A-N assigned to them at the given origin, destination, time.

A transportation provider 120A-N may be required to pay a user fee to the matching service 130 for each set of users 110A-N assigned to the transportation provider 120A. The user fee may be a percentage, such as ten percent, of the route bid price, or fare, specified by the transportation provider 120A-N for the given origin x, destination y and date/time z. Alternatively, the user fee may be in the form of a user bid price submitted by the transportation providers 120A-N. The user bid price may indicate the amount a transportation provider 120A-N may pay the matching service 130, for each user 110A-N matched with the transportation provider 120A-N.

If the transportation provider 120A-N fails to provide transportation to the users 110A-N, the users 110A-N may be compensated for the inconvenience with the user fee paid by the transportation provider 120A-N. If the users 110A-N fail to interact with the transportation provider 120A-N at the origin x, the transportation provider may be able to file a claim to the matching service 130 to be reimbursed for the user fee. In this instance, the matching service 130 may refund the amount paid by the transportation provider 120A-N.

The match between the user A 110A and the user B 110B and a transportation provider 120A-N may be based on a relevance value for each transportation provider 120A-N. The relevance value may be calculated by determining the best fit between the preferences of the user A 110A and the user B 110B and the preferences of each transportation provider 120A-N. The preferences may include ranking or valuating different characteristics of a transportation provider 120A-N, such as the importance of the fare cost, the importance of reliability, the importance of punctuality, or generally any characteristic of a transportation provider 120A-N, or lack there of, that may be of important to a user 110A-N. The relevance value may be a numerical value or a percentage. The relevance value may then be multiplied by the user fee of each transportation provider 120A-N to determine a total score. The transportation provider 120A-N with the highest total score may be assigned the user A 110A and the user B 110B.

Alternatively or in addition, the user bid price may not be set and the one or more transportation providers 120A-N may participate in a live auction to bid on a user fee to be paid to the service provider servers 120A-N for the right to transport the user A 110A and the user B 110B. The transportation provider A 120A with the highest bid may be assigned to the user A 110A and the user B 110B and may pay the bid price to the matching service 130.

If the user A 110A declines the transportation share request of the user B 110B, the matching service 130 may continue to attempt to match the user A 110A with the other users 110B-N. If the current date/time begins to approach the transportation date/time z specified by the user A 110A, the matching service 130 may match user A 110A to a transportation provider A 120A from the transportation providers 120A-N without matching any other users 110B-N to transportation provider A 120A. The user A 110A may obtain a discounted rate for using the service even though no match could be made. Alternatively or in addition, the user A 110A may have identified a preference to cancel the request to be matched with a transportation provider A 120A if the user A 110A could not be matched with another user. In this case, when the current date/time approaches the transportation date/time z specified by the user A 110A, the matching service 130 may communicate to the user A 110A that a match could not be found and their request has been cancelled.

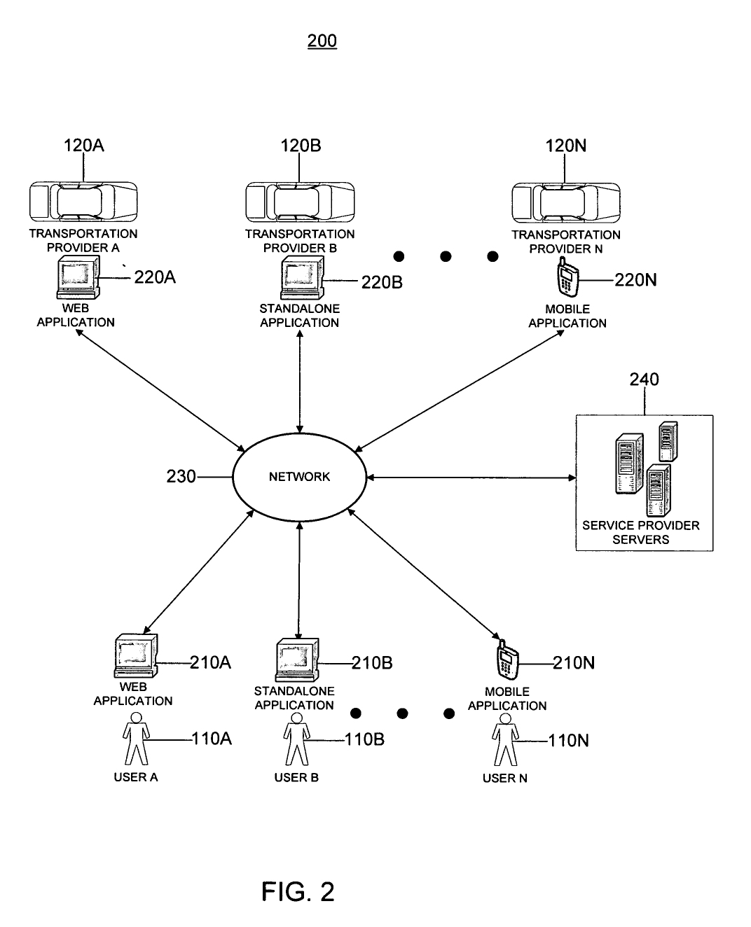

FIG. 2 provides a simplified view of a network environment implementing a system 200 for matching one or more users, such as users 110A-N and a transportation provider such as transportation providers 120A-N. The system 200 may include one or more web applications, standalone applications and mobile applications 220A-N, which may be collectively or individually referred to as client applications for the transportation providers 120A-N. The system 200 may also include one or more web applications, standalone applications, mobile applications 210A-N, which may collectively be referred to as client applications or individually as a user client application. The system 200 may also include a network 230, and the service provider servers 240.

The users 110A-N may use either a web application 210A, standalone application 210B, or a mobile application 210N, or any combination thereof, to communicate to the service provider servers 240, such as via the network 230. The network 230 may include wide area networks (WAN), such as the internet, local area networks (LAN), campus area networks, metropolitan area networks, or any other networks that may allow for data communication. Similarly, the transportation providers 120A-N may use either a web application 210A, a standalone application 210B, or a mobile application 210N to communicate to the service provider servers 240, via the network 230. The service provider servers 240 may communicate to the users 110A-N via the network 230, through the web applications, standalone applications or mobile applications 210A-N. The service provider servers 240 may also communicate to the transportation providers 120A-N via the network 240, through the web applications, standalone applications or mobile applications 220A-N.

The web applications, standalone applications and mobile applications 210A-N, 220A-N may be connected to the network 230 in any configuration that supports data transfer. This may include a data connection to the network 230 that may be wired or wireless. Any of the web applications, standalone applications and mobile applications 210A-N, 220A-N may individually be referred to as a client application. The web applications 210A, 220A may run on any platform that supports web content, such as a web browser or a computer, a mobile phone, or any appliance capable of data communications.

The standalone applications 210B, 220B may run on a machine that may have a processor, memory, a display, and an interface. The processor may be operatively connected to the memory, display and the interface and may perform tasks at the request of the standalone applications 210B, 220B or the underlying operating system, such as matching a user with a transportation provider. The memory may be capable of storing data. The display may be operatively connected to the memory and the processor and may be capable of displaying information to the user B 110B or the transportation provider B 120B. The interface may be operatively connected to the memory, the processor, and the display. The standalone applications 210B, 220B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others. The standalone applications 210B, 220B may be third party standalone applications or may be third party servers.

The mobile applications 210N, 220N may run on any mobile device that may have a data connection. The data connection may be a cellular connection, a wireless date connection, an internet connection, an infra-red connection, a Bluetooth connection, or any other connection capable of transmitting data.

The service provider servers 240 may include one or more of the following: an application server, a data source, such as a database server, and a middleware server. The service provider servers 240 may co-exist on one machine or may be running in a distributed configuration on one or more machines. The service provider servers 240 may collectively be referred to as the server.

There may be several configurations of database servers, application servers and middleware servers that may support such a system 200. Database servers may include MICROSOFT SQL SERVER, ORACLE, IBM DB2 or any other database software, relational or otherwise. The application server may be APACHE TOMCAT, MICROSOFT IIS, ADOBE COLDFUSION, yapache or any other application server that supports communication protocols. The middleware server may be any middleware that connects software components or applications.

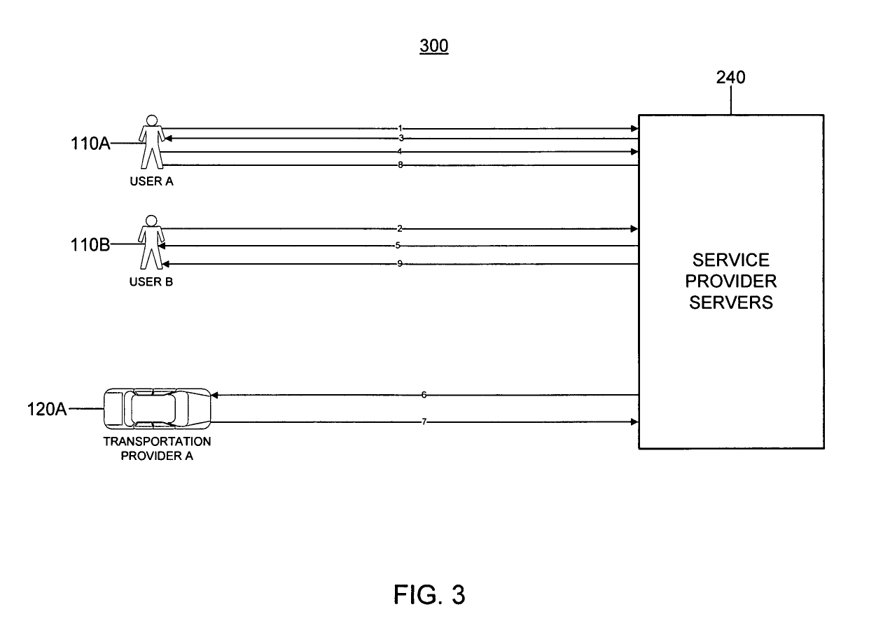

FIG. 3 provides an example of the workflow of a system 200 for matching a first user to a second user and then matching both users to a transportation provider. FIG. 3 demonstrates interactions between the user A 110A, the user B 110B, the transportation provider A 120A and the service provider servers 240.

At 1, the user A 110A may communicate to the service provider servers 240 their availability to share transportation with a second user from origin x to destination y, at date/time z. The service provider servers 240 may display the transportation share request of the user A 110A to the other users 110B-N if there is a transportation provider 120A-N currently available to supply transportation from origin x to destination y at date/time z. If there is no transportation provider 120A-N available, the service provider servers 240 may communicate that to the user A 110A that no transportation providers 120A-N are available for transport from origin x, to destination y at date/time z. At 2 the user B 110B may view the user A 110A availability to share transportation from origin x to destination y, at date/time z, and may communicate to the service provider servers 240 a request to share transportation with the user A 110A. If the user B 110B is traveling to a destination different than the user A 110A destination y, then the user B 110B may communicate their destination to the service provider servers 240.

At 3, the service provider servers 240 may notify user A 110A of the user B 110B transportation share request. The user A 110A may accept or decline the user B 110B transportation share request. The user A 110A decision may be based on a user reputation value of the user B 110B. The user B 110B reputation value may be based on the opinions of other users 110A-N who have previously shared transportation with the user B 110B. The user reputation value may assist the users 110A-N in determining whether to share transportation with the user B 110B.

The users 110A-N may also supply identifying information, such as personal information, so that the system 200 may identify users 110A-N who misuse the system 200 ensuring that the users 110A-N may be comfortable knowing that users who misuse the system 200 may be identified. Some personal information may be exposed to all of the users 110A-N, such as age, gender, or any other general characteristic that may assist in selecting a user 110A-N to share transportation with. Some personal information may be kept private and only exposed only to the matching service 130, such as full name, address, telephone number, etc. The personal information kept private may be viewed when a dispute or problem between two users 110A-N arises.

The user A 110A may also base their decision on the proximity to the user B 110B destination if the user B 110B destination differs from the user A 110A destination y. The user A 110A may desire to only share transportation with a user whose destination is within a certain proximity of the user A 110A destination y, or within a certain proximity of the route the user A 110A may take to their destination y. The user A 110A may be able to set a proximity preference. If the user B 110B destination is not within the user A 110A set proximity of the user A 110A route or destination, the user B 110B may not be able to request a transportation share with the user A 110A or the user A 110A may not appear to the user B 110B as available for sharing transportation.

At 4 the user A 110A may communicate to the service provider servers 240 an acceptance of the user B 110B transportation share request. At 5, the service provider servers 240 may notify the user B 110B that the user A 110A accepted their transportation share request. After being matched with the user B 110B, the user A 110A may choose to either close their transportation share availability, or leave their transportation availability open for more users to join. The user A 110A transportation share availability may automatically be closed by the service provider servers 240 within a fixed time of date/time z. Alternatively or in addition, the user A 110A may specify the amount of time before the date/time z when their transportation share availability should close.

If the user A 110A keeps their transportation share availability open, additional users may request to share transportation with the user A 110A and the user B 110B. The transportation share request of a third user, such as user N 110N, may need to be accepted by the user A 110A and/or the user B 110B.

At 6 the service provider servers 240 may match the users 110A and 110B to the transportation provider A 120A, such as a taxi cab provider and notify the transportation provider A 120A of the matching. The service provider servers 240 may take several factors into account when matching the user A 110A and the user B 110B to the transportation provider A 120A. The user A 110A and/or the user B 110B may have identified preferred transportation providers before, or at the time of, making the transportation share request. If the user A 110A and/or the user B 110B identified preferred transportation providers, the service provider servers 240 may offer the transportation of the user A 110A and the user B 110B to their preferred transportation providers.

The user A 110A and/or the user B 110B may determine their preferred transportation providers based on their own experience or on the transportation provider reputation value. The transportation provider A 120A reputation value may be based on the experience of the users 110A-N with the transportation provider A 120A. After being transported by the transportation provider A 120A, the user A 110A and/or the user B 110B may have the opportunity to provide a reputation value for the transportation provider A 120A and each other. The reputation values may assist the users 110A-N in selecting preferred transportation providers 120A-N.

The service provider servers 240 may determine a relevance value for each transportation provider 120A-N that may be a function of the preferences of the user A 110A, the user B 110B and the transportation providers 120A-N. The relevance value may represent the correlation between the user A 110A and the user B 110B's preferences and the transportation provider 120A-N characteristics or attributes. The relevance value may then be used in conjunction with the user fee of each transportation provider 120A-N to determine a total score, such as multiplying the relevance value by the user fee paid. The transportation provider with the highest score may be assigned to transport the user A 110A and the user B 110B.

At 7 the transportation provider A 120A may pay the user fee to the matching service 130 for being matched to the user A 110A and the user B 110B. The user fee may be based on a percentage of the transportation provider A 120A route bid price, such as ten percent, or may be the transportation provider A 120A user bid price.

At 8 the user A 110A may be notified that the transportation provider A 120A may be providing transportation to the user A 110A and the user B 110B from origin x to destination y, at date/time z. The user A 110A may be notified via an email, a text message, a voice message, or any other method of communication that may be capable of notifying the user A 110A. At 9 the user B 110B may be notified of the transportation provider A 120A acceptance of providing transportation to the user A 110A and the user B 110B from origin x to destination y, at date/time z. The user B 110B may be notified via an email, a text message, a voice message, or any other method of communication that may be capable of notifying the user B 110B.

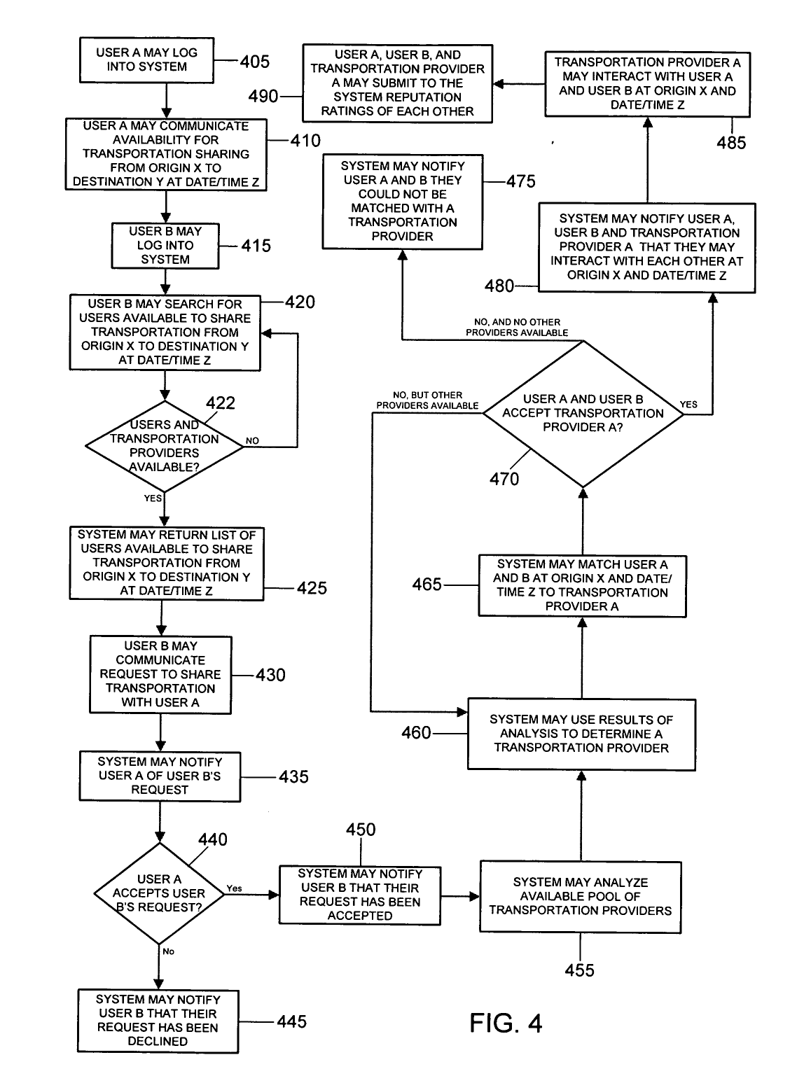

FIG. 4 is a flowchart illustrating the basic operations of a system 200 for matching a first user to a second user and then matching both users to a transportation provider. At block 405 the user A 110A may log into the system 200. The user A 110A may access the system 200 from any device with a data connection, such as a web application 210A, a standalone application 210B, or a mobile application 210N. At block 410 the user A 110A may communicate to the service provider servers 240 the user A 110A availability to share transportation from origin x to destination y, at date/time z. The service provider servers 240 may store the user A 110A availability from origin x to destination y, at date/time z, such as storing the data in a database.

If at the time the user A 110A logs into the system 200 there are no transportation providers 120A-N available to provide transportation from origin x to destination y at date/time z, the service provider servers 240 may communicate to the user A 110A that no transportation providers 120A-N are available and may ask the user A 110A to try again later. Alternatively or in addition, the user A 110A may be able to submit their contact information, such as an email, address, phone number, etc., and may be notified by the service provider servers 240 if a transportation provider becomes available to provide transportation from origin x to destination y at date/time z.

At block 415, the user B 110B may log into the system 200. The user B 110B may access the system 200 from any device with a data connection, such as a web application 210A, a standalone application 210B, or a mobile application 210N. At block 420 the user B 110B may communicate to the service provider servers 240 an availability search for users available for sharing transportation from origin x to destination y, at date/time z. The user B 110B may enter a physical location address to identify the origin x they wish to share transportation from and/or the destination y, or the user B 110B may select a region on a map to identify an area from which they wish to share transportation from and/or to. Similarly the user B 110B may search for availability to share transportation at a specific date/time z or may search across a range of date/time values.

At block 422, the system 200 may determine whether there are users 110A-N available for the user B 110B to share transportation with, and transportation providers 120A-N available for transporting the user B 110B from origin x to destination y at date/time z. If there are no users 110A-N available to share transportation with the user B 110B or if there are no transportation providers 120A-N available to transport the user B 110B, the user B 110B may be notified that there are no users 110A-N or transportation providers 120A-N available, and the system 200 may move back to block 420 where the user B 110B may perform another search. If there are users 110A-N available to share transportation with the user B 110B, and if there are transportation providers 120A-N available to transport the user B 110B, the system 200 may move to block 425.

At block 425 the system 200 may communicate to the user B 110B a list of other users 110A-N available to share transportation from the origin x to the destination y, at the date/time z. The user B 110B may survey the list of users to find one or more users to share transportation with. The list of users may be ordered based on the proximity of the users' origins and destinations relative to the user B 110B origin x and destination y or the list of users may be ordered based on a value associated with an attribute or characteristic of the users. The user B 110B may request to share transportation with the user A 110A based on the attribute values of the user A 110A. In addition, or alternatively or in addition, the system 200 may automatically pair two users 110A-N.

After sharing transportation, each user may give feedback on, or rate, the users they shared the transportation with. One of these ratings may be a reputation value, indicating generally how reputable a user was. There may be other characteristics of the user A 110A that may be rated, such as timeliness, hygiene, friendliness, attractiveness, or generally any characteristic or attribute that may be useful in determining whether the user A 110A is desirable to share transportation with. The user A 110A may also have an experience value, which may indicate the number of times they have engaged in transportation sharing in the past. An experience value may add context to the other values associated with the user A 110A.

The metrics associated with rating the user A 110A may take on different forms. A characteristic of the user A 110A may be designated by a value, such as with a 1 for positive feedback or a −1 for negative feedback. In this instance the individual values may be summed to determine an overall value of the characteristic. Alternatively or in addition, the characteristic of the user A 110A may be rated on a scale of 1 to 10 or 1 to 100, or some other range. The overall value of the characteristic may be determined by averaging the individual values.

Alternatively or in addition, the reputation value of the user A 110A may not be directly rated by the users 110B-N, but may be based on the other characteristic values of the user A 110A. The service provider servers 240 may perform calculations on the user A 110A characteristic values to determine the user A 110A reputation value. The user A 110A experience value, or the number of times the user A 110A may have used the system 200 to share transportation, may factor into the calculation of the user A 110A reputation value to add a layer of context to the user A 110A reputation value.

Alternatively or in addition, external values associated with the user A 110A may be imported into the system 200 from other systems the user A 110A may participate in. For example, the values may be from online auction systems, online dating systems, online chat systems, or generally any system that may supply values of characteristics of the user A 110A that may be relevant to the system for sharing transportation 200. The external characteristic values may be listed individually or may be factored into the calculation of the user A 110A overall reputation value.

The system for sharing transportation 200 may be linked to other systems that match the users 110A-N together, such as a dating system. When linking to external systems, the service provider servers 240 may communicate with the external systems through the network 240. In the case of a dating system, users 110A-N may be able to coordinate a date with sharing transportation. If the user B 110B uses both the transportation sharing system and the dating system, the user B 110B list of available users 110A-N may include information identifying which users 110A-N participate in the dating system. The list of users 110A-N may be ordered based on which users 110A-N may be the best match for sharing transportation with the user B 110B and dating the user B 110B.

The user B 110B may determine that the user A 110A may be desirable to share transportation with. In this case, at block 430 the user B 110B may communicate to the service provider servers 240 a request to share transportation with user A 110A. Alternatively or in addition, the user B 110B may communicate directly with the user A 110A and the transportation providers 120A-N, such as eliminate the need for the service provider servers 240 to act as an intermediary in any of the operations.

At block 435 the service provider servers 240 may communicate to the user A 110A that the user B 110B has requested to share transportation with the user A 110A. The service provider servers 240 may also provide the user A 110A with the reputation value and any other values associated with the user B 110B. At block 440, the user A 110A decides whether to accept the user B 110B request to share transportation. The user A 110A decision may rely on the reputation value and any other characteristic values of the user B 110B. If the user A 110A finds the user B 110B undesirable to share transportation with, the user A 110B may communicate a declination to the service provider servers 240, and the system 200 may move to block 445. At block 445 the service provider servers 240 may communicate to the user B 110B that the user A 110A has declined the user B 110B request to share transportation. If there are other users 110A-N available to share transportation, the service provider servers 240 may communicate a list of other users 110A-N available to share transportation. In this instance the user B 110B may request to share transportation with one of the other users 110A-N.

If the user A 110A decides to accept the user B 110B request to share transportation, the user A 110A may communicate their acceptance to the service provider servers 240. At block 450 the service provider servers 240 may notify the user B 110B that their request to share transportation has been accepted by the user A 110A. After two or more users have been matched, the service provider servers 240 may begin determining a transportation provider A 120A to match to the user A 110A and the user B 110B.

At block 455 the service provider servers 240 may analyze the available pool of transportation providers 120A-N. At block 460 the system 200 may use the analysis to determine a transportation provider A 120A to be matched with the user A 110A and the user B 110B, such as the transportation provider A 120A. Several factors may affect the analysis of available transportation providers 120A-N. If the user A 110A or the user B 110B specified preferred transportation providers, the service provider servers 240 may attempt to match the user A 110A and the user B 110B with one of their preferred transportation providers or the service provider servers may 240 may attempt to match the user A 110A and the user B 110B to a transportation provider 120A-N based on the aforementioned total scores of each of the individual transportation providers 120A-N. A total score may be calculated by multiplying the transportation provider 120A-N relevance value and the amount paid by the transportation provider 120A-N to the matching service 130 for users 110A-N, such as the user fee or the user bid price. The transportation provider 120A-N with the highest total score may be matched to the user A 110A and the user B 110B.

In addition, the user A 110A and/or the user B 110B may specify a transportation provider reputation value threshold. In this case the service provider servers 240 may not match the user A 110A and the user B 110B to any transportation provider with a reputation value below the transportation provider reputation value threshold specified by the user A 110A and/or the user B 110B. The system 200 may provide a price associated with the value threshold provided by the user A 110A and/or the user B 110B. For example, a transportation provider 120A-N with a higher reputation value may be associated with a higher price than a transportation provider 120A-N with a lower reputation value.

Alternatively or in addition, the transportation providers 120A-N may submit bids for the right to provide transportation to any of the users 110A-N. The transportation providers 120A-N may submit a bid amount they may be willing to pay each time they are matched with users 110A-N. The transportation providers 120A-N may also be able to submit bids filtered by the origin x of the users 110A-N, the destination y of the users 110A-N, the date/time z of the transportation of the users 110A-N, and generally any characteristic that may benefit from a specific bidding process.

The transportation providers 120A-N may submit bids for the users 110A-N in advance of being matched to the users 110A-N. In this instance, a transportation provider A 120A may submit maximum bids for users 110A-N in general, or for specific users 110A-N. Alternatively or in addition, specific users 110A-N may be bid on in a real-time auction format. The transportation providers 120A-N may log into the system 200, view and bid on the users 110A-N that may be waiting to be matched to a transportation provider. The auction may end at a fixed time prior to the date/time z when users 110A-N are to be transported, or may end if a transportation provider A 120A is willing to pay a set fixed price for the users 110A-N.

At block 465, the service provider servers 240 may match the user A 110 A and the user B 110B to the transportation provider A 120A. At block 470, the service provider servers 240 may request acceptance of the transportation provider A 120A from the user A 110A and the user B 110B. For instance, the service provider servers 240 may communicate an email to the user A 110A and the user B 110B with one link corresponding to accepting the transportation provider A 120A and one link corresponding to declining the transportation provider A 120A. One or both of the user A 110A and the user B 110B may need to communicate an acceptance of the transportation provider A 120A

If the user A 110A or the user B 110B communicates a declination to the service provider servers 240, and other transportation providers 120B-N from the analysis in block 455 are available, the system 200 may move to block 460 to determine another transportation provider to be offered to the user A 110A and the user B 110B, such as the transportation provider B 120B. The transportation provider 120B-N with the next highest total score may be offered to the user A 110A and the user B 110B. Alternatively or in addition, the user A 110A and the user B 110B may not have the option to accept or decline the transportation provider 120A. Furthermore the transportation provider A 120A may have the option to accept or decline the user A 110A and the user B 110B.

If the user A 110A or the user B 110B communicates a declination to the service provider servers 240, and no transportation providers 120A-N from the analysis in block 455 remain, then the system 200 may move to block 475. At block 475, the service provider servers 240 may communicate to the user A 110A and the user B 110B that they could not be matched with a transportation provider.

If the user A 110A and the user B 110B communicate an acceptance of the transportation provider A 120A to the service provider servers 240, the system 200 may proceed to block 480. At block 480 the service provider servers 240 may communicate to the user A 110A, the user B 110B and the transportation provider A 120A that they may interact with each other at origin x and date/time z.

At block 485 the transportation provider A 120A may interact with the user A 110A and the user B 110B at origin x and date/time z, such as transporting them from the origin x to the destination y. The interaction may include communicating directly with the user A 110A and/or the user B 110B to coordinate meeting the user A 110A and the user B 110B. The interaction may include displaying a placard with identifying information regarding the user A 110A and the user B 110B, such as their names, so that the user A 110A and the user B 110B may identify the transportation provider A 120A. The user A 110A and/or the user B 110B may pay the transportation provider A 120A directly for the transportation provided, or the service provider servers 240 may coordinate a payment from the user A 110A and/or the user B 110B to the transportation provider A 120A before or after the transportation is provided.

After the user A 110A and the user B 110B have interacted with the transportation provider A 120A, the system 200 may move to block 490. At block 490, the user A 110A, the user B 110B and the transportation provider A 120A may determine reputation ratings of each other based on their experience with each other. The user A 110A and the user B 110B may rate the transportation provider A 120A and each other and the transportation provider A 120A may rate the user A 110A and the user B 110B. The transportation provider A 120A may rate the user A 110A and the user B 110B based on one or more characteristics, such as the users 110A-N punctuality, conversation, tips, general hygiene, or any other characteristic that may assist a transportation provider A 120A determine whether to accept a user A 110A. The transportation provider A 120A ratings of the user A 110A and the user B 110B may be tabulated separately from the user A 110A and the user B 110B ratings of each other.

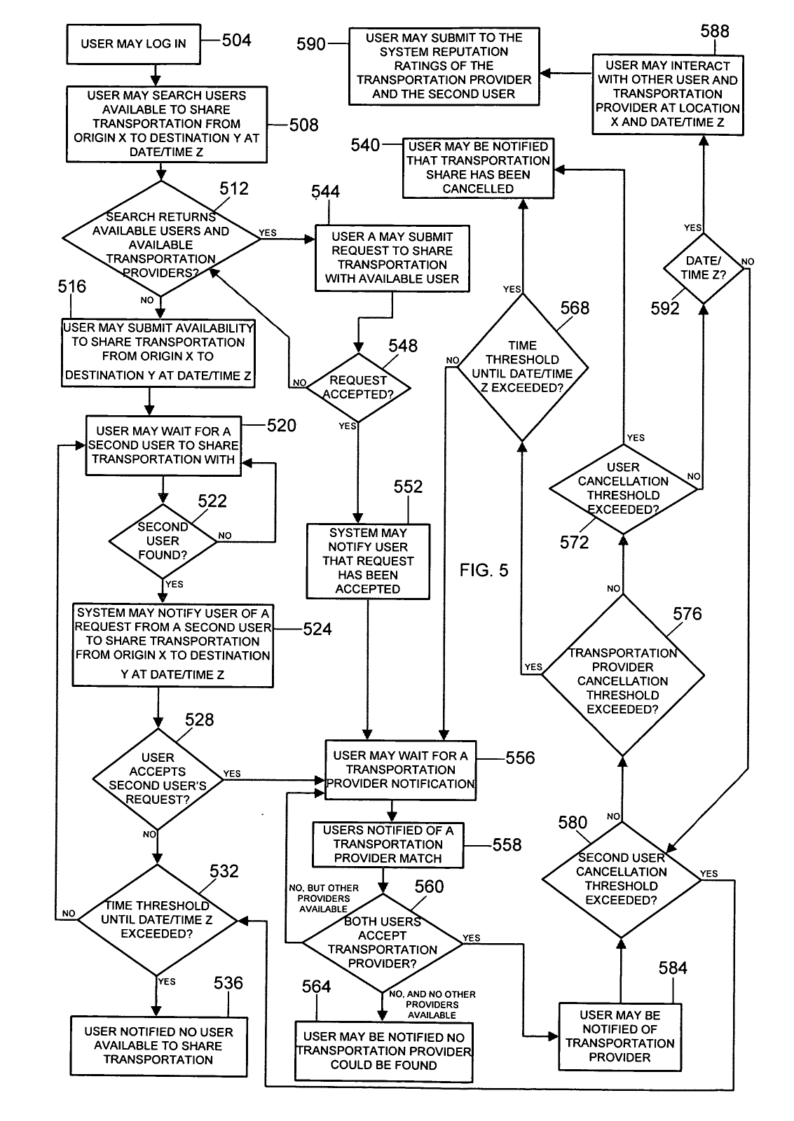

FIG. 5 is a flowchart illustrating steps that may be taken by a user in a system 200 for matching a first user to a second user and then matching both users to a transportation provider. At block 504 a user A 110A may log in to the system 200. The method of logging into the system 200 may depend on the interface the user A 110A is using to access the system 200. In the case of a web application, the user A 110A may log into the system 200 via a web page.

The user A 110A may log into the system 200 for the purpose of finding users 110B-N to share transportation from an origin x to a destination y at a specific date/time z. At block 508 the user A 110A may search the system 200 for users 110B-N available to share transportation from a particular origin x to a destination y at a specific date/time z. For purposes of explanation, the system 200 is described in terms of the users performing certain action. In the alternative, or in addition, the system 200 may automatically perform the actions. The user can supply information to the system 200 such that the system can perform the actions. The user A 110A may search for available users 110B-N based on a physical location address of the origin and/or the destination or a general geographic area representing the origin and/or destination. The user A 110A may search for available users 110B-N based on a specific date/time or a date/time range. The user A 110A may further filter the search for available users 110B-N whose reputation value exceeds a minimum reputation value. In this instance, the system 200 may return users 110B-N whose reputation values exceed the minimum reputation value set by the user A 110A. The system 200 may also allow the user A 110A to set a minimum reputation value in their preferences. In this case, the system 200 may filter each of the user A 110A availability searches based on the user A 110A set minimum reputation value.

At block 512 the system 200 may determine whether any users 110B-N meet the user A 110A search criteria and whether there are any transportation providers 120A-N available to provide transportation from origin x to destination y at date/time z. If the user A 110A search returns available users 110B-N and an available transportation provider 120A-N, then the system 200 may move to block 544. If the user A 110A search does not return available users 110B-N, the system 200 may move to block 516. If the user A 110A search does return available users 110B-N, the system 200 may move to block 544. If the user A 110A search does not return at least one available transportation provider, the system 200 may notify the user A 110A that no transportation providers 120A-N are available and ask the user A 110A to try again later. The system 200 may also give the user A 110A the option to leave contact information, such as an email address or a phone number, in order to be notified if a transportation provider 120A-N becomes available.

At block 516, the user A 110A may submit to the system 200 their availability to share transportation from origin x to destination y at date/time z. If the user A 110A is accessing the system 200 through a web application 210A, the user A 110A may submit a physical location address to represent the origin x and/or the destination y, or may select a geographic area on the web application 210A to represent the origin x and/or the destination y. In addition, or alternatively or in addition, the information may be automatically set, such as by the device being used by the user 110A-N. For example, the device may include a global positioning satellite (GPS) chip. The user A 110A may select a specific time to represent the date/time z or the user A 110A may select a date/time range to represent the date/time z.

After the user A 110A submits their availability, the system 200 may move to block 520, where the user A 110A waits for a second user, such as the user B 110B, to share transportation with. The user A 110A may wait for a second user to share transportation with until a fixed time before the date/time z. The system 200 may continue to block 522 while the user A 110A waits for a second user to share transportation with.

At block 522 the system 200 may determine whether a second user, such as the user B 110B, has been found to match with the user A 110A. If a second user has been found to match with the user A 110A, then the system 200 may move to block 524. If a second user has not been found to match with the user A 110A then the system 200 may move to block 532. In this instance, a second user may be found when a second user logs into the system 200 and requests to share transportation with the user A 110A.

At block 532 the system 200 may determine whether the time threshold until date/time z has been exceeded. As used herein, threshold may be established such that they may or may not be met by being exceeded. The system 200 may establish a default minimum time threshold that represents the minimum amount of time before date/time z that the user A 110A may continue to wait for a second user to share transportation with. Alternatively or in addition, the user A 110A may set their minimum date/time threshold. The date/time threshold may be exceeded when the amount of time specified in the date/time threshold surpasses the time until date/time z. For instance, if the user A 110A set their minimum time threshold as one hour, then once the current time is within one hour of the date/time z, the system 200 may no longer attempt to match the user A 110A with a second user.

Some users 110A-N may desire to coordinate all of their transportation arrangements in advance; therefore they may desire a large date/time threshold. A larger date/time threshold may cause the system 200 to abandon the transportation sharing well in advance of the date/time z. Other users 110A-N may desire to interact with the system 200 in real-time. These users 110A-N may desire an small date/time threshold or may desire no date/time threshold at all. By establishing a small or non-existent date/time threshold the system 200 may continue to attempt to match the user A 110A with other users 110B-N until the user A 110A cancels the request.

For example, a user A 110A may be at an airport and may want the system 200 to attempt to match them to other users 110B-N until the user A 110A decides to take unshared transportation. Alternatively or in addition, A user A 110A may want the system 200 to continue to attempt to match them to other users 110B-N even while they are being provided transportation. For example, a user A 110A may get into a taxicab from the airport and may desire the system 200 to continuously attempt to match them with users 110B-N along the way. In this case the user A 110A or the transportation provider A 120A may need to supply location information, such as GPS coordinates, to enable the system 200 to determine the user A 110A real time location. Furthermore, the user A 110A may establish a distance threshold that may indicate the maximum distance from their current location to search for available users 110B-N.

If the time threshold until date/time z has not been exceeded, then the system 200 may move back to block 520 and the user A 110A may continue to wait for another user to share transportation with. If the time threshold until date/time z is exceeded then the system 200 may move to block 536. At block 536 the user A 110A may be notified that no other user could be found to share transportation. This notification may take place in the form of an email, a text message, or any form of communication that generally relates to the manner in which the user A 110A accesses the system 200.

If a second user, such as the user B 110B, has been found to match with the user A 110A at block 522, then the system 200 may move to block 524. At block 524 the user A 110A may be notified that the user B 110B has requested to share transportation with the user A 110A from the origin x to destination y, at date/time z, as specified by the user A 110A. After notifying the user A 110A, the system 200 may move to block 528.

At block 528, the user A 110A may decide whether to accept the user B 110B request to share transportation. The user A 110A may make this determination based on the reputation value of the user B 110B or any other characteristic values associated with the second user. The proximity between the origin of the user A 110A and the origin of the user B 110B and the proximity between the destination of the user A 110A and the user B 110B may also factor in to the user A 110A decision.

If the user A 110A decides to decline the request of the user B 110B, the system 200 may move to block 532. At block 532, the system 200 may determine whether the time threshold until date/time z has passed. If the time threshold until date/time z has been exceeded, the system 200 may move to block 536, where the user A 110A may be notified that no other user could be found to share transportation with. If the time threshold until date/time z has not been exceeded, the system 200 may move to block 520 where the user A 110A may continue to wait for another user to share transportation with.

If the user A 110A decides to accept the user B 110B request to share transportation from the origin x to the destination y at date/time z, the system 200 may move to block 556. At block 556 the user A 110A may wait for a notification that a transportation provider has been found, such as the transportation provider A 120A. At block 558 the user A 110A and the user B 110B may be notified of being matched to the transportation provider A 120A and may be required to submit an acceptance or declination of the transportation provider A 120A.

At block 560, the user A 110A and the user B 110 may be required to submit an acceptance or a declination of the transportation provider A 120A. One or both of the user A 110A and the user B 110B may need to communicate an acceptance of the transportation provider A 120A The user A 110A and the user B 110B may be required to accept the transportation provider A 120A within a specified time limit, such as six hours, or system may enter a decline of the transportation provider A 120A by default.

If the user A 110A or the user B 110B communicates a declination to the service provider servers 240, and other transportation providers 120B-N are available, the system 200 may move to block 556 where the user A 110A and the user B 110B may wait to be notified of being matched to another transportation provider 120B-N. The transportation provider 120B-N with the next highest total score may then be offered to the user A 110A and the user B 110B. The system 200 may have a limit on the number of times the user A 110A or the user B 110B may decline a transportation provider 120A-N. If the user A 110A and the user B 110B exceed the system 200 declination limit, they may be notified that they could not be matched with a transportation provider 120A-N.

If the user A 110A or the user B 110B communicates a declination to the service provider servers 240, and no available transportation providers 120A-N remain, then the system 200 may move to block 564. At block 564 the user A 110A may be notified that no transportation provider 120A-N could be found.

If the user A 110A and the user B 110B communicate an acceptance of the transportation provider A 120A to the service provider servers 240, the system 200 may proceed to block 584. At block 584, the system 200 may notify the user A 110A and the user B 110B that they have been matched to a transportation provider 120A-N, such as the transportation provider A 120A.

After the user A 110A and the user B 110B accept the transportation provider A 120A, the system 200 may move to blocks 580, 576, 572, and 592. Blocks 580, 576, and 572 may operate in a loop to repeatedly, such as constantly or periodically, determine whether certain threshold levels have been passed until the date/time z arrives.

At block 580, the system 200 may determine whether the user B 110B cancellation threshold may have been exceeded. There may be several factors that may contribute to the second user exceeding of the user B 110B cancellation threshold. If the user B 110B cancels their transportation share request, the user B 110B cancellation threshold may be exceeded. If the user B 110B is being transported to the origin x by a third party, such as an airlines, and the third party experiences delays, user B 110B cancellation threshold may be exceeded. The system 200 may have a default maximum delay time that represents the maximum delay after date/time z that the system 200 may hold the transportation share request. If the user B 110B flight is delayed, and the delay exceeds the maximum delay time then the user B 110B cancellation threshold may be exceeded.

If the user A 110A or the user B 110B supplies third party travel information to the system 200, such as flight information, the system 200 may retrieve all publicly available data associated with the travel information and use the retrieved data in determining the cancellation thresholds. The service provider servers 240 may communicate with the external travel systems, via the network 230 to retrieve the data. For instance, if the user B 110B supplies a flight number, the service provider servers 240 may automatically attempt to retrieve the flight status from the airlines data system via the network 230. If the flight status indicates the user B 110B may be delayed, the system 200 may determine whether the delay exceeds the maximum delay time and whether the user B 110B may have exceeded their cancellation threshold.

If the user B 110B exceeds their cancellation threshold, the system 200 may move to block 532. At block 532, the system 200 may determine whether the date/time threshold until date/time z may have been exceeded. If the date/time threshold until date/time z has not been exceeded, the system 200 may move to block 520 where the user A 110A waits to be matched with another user. If the date/time threshold until date/time z has been exceeded then the system may move to block 536, where the user A 110A may be notified that no users could be found to share transportation.

At block 576, the system 200 may determine whether the transportation provider A 120A may have exceeded their cancellation threshold. There may be several ways in which the transportation provider A 120A cancellation threshold may be exceeded. If the transportation provider A 120A cancels their acceptance of the user A 110A and the user B 110B, their cancellation threshold may be exceeded. If the user A 110A or the user B 110B are interacting in real-time and the coordinates of the transportation provider A 120A transportation indicate that the transportation provider A 120A is being delayed beyond the maximum delay time, the transportation provider A 120A cancellation threshold may be exceeded.

If the transportation provider A 120A cancellation threshold is exceeded the system 200 may move to block 568. At block 568, the system 200 may determine whether the time threshold until date/time z may have been exceeded. If the time threshold may have been exceeded, the system 200 may move to block 540. At block 540 the system 200 may notify the user A 110A that their transportation share has been cancelled. The system 200 may communicate to the user A 110A via any of the aforementioned modes. If the date/time threshold until date/time z has not been exceeded, the system 200 may move to block 556 where the user A 110A waits for the system 200 to determine an alternate transportation provider.

At block 572, the system 200 may determine whether the user A 110A cancellation threshold may have been exceeded. The same factors that may result in a exceed of the user B 110B cancellation threshold may result in a exceed of the user A 110A cancellation threshold. If the user A 110A cancellation threshold is exceeded, the system 200 may move to block 540. At block 540, the user A 110A is notified that their transportation share has been cancelled. If the user A 110A date/time threshold is not exceeded the system 200 may move to block 592.

At block 592, the system 200 may determine whether the current time is equal to or past the date/time z. If the current time is equal to or past the date/time z, then the system 200 may move to block 588. At block 588 the user A 110A may interact with the user B 110B and the transportation provider A 120A at the origin x and date/time z. After the user A 110A has interacted with the user B 110B and the transportation provider A 120A, the system 200 may move to block 590. At block 590, the user A 110A, the user B 110B, and the transportation provider A 120A may provide the aforementioned reputation ratings of each other based on their experience with each other. The user A 110A and the user B 110B may rate the transportation provider A 120A and each other, and the transportation provider A 120A may rate the user A 110A and the user B 110B.

If the current time is not equal to or past the date/time z, the system 200 may move back to block 580 and may continue to determine whether the cancellation thresholds have been exceeded. Alternatively or in addition, the system 200 may simultaneously monitor all of the cancellation thresholds.

At block 512, if the user A 110A search returns other users 110B-N available for sharing transportation, the system 200 may move to block 544. At block 544 the user A 110A may submit a request to the system 200 to share transportation with one of the available users 110B-N returned by the search, such as the user B 110B. At block 548 the system 200 may determine whether the user B 110B accepted or declined the user A 110A request. If the user B 110B declined the user A 110A request, the system 200 may move back to block 512, where the system 200 returns other available users 110A-N. If the user B 110B accepted the request from the user A 110A, then the system 200 may proceed to block 552. At block 552, the user A 110A may be notified that their request to share transportation has been accepted by the user B 110B. The system 200 then may proceed to block 556, where the user A 110A waits to be notified of a transportation provider.

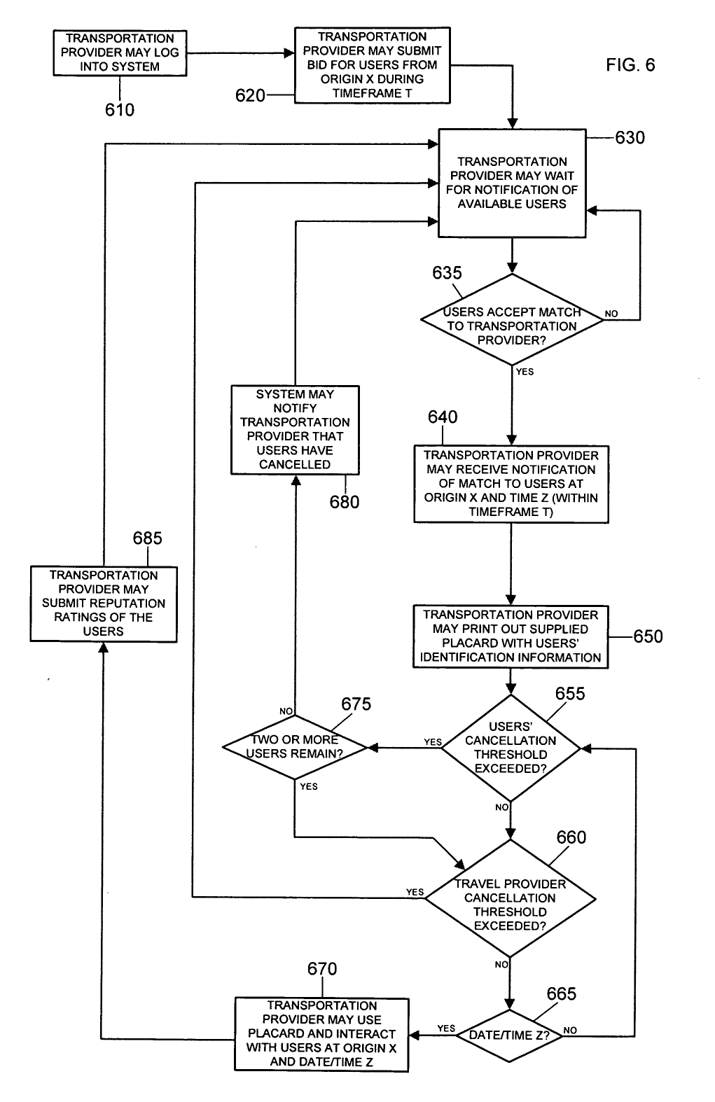

FIG. 6 is a flowchart illustrating the steps that may be taken by a transportation provider in a system 200 for matching one or more users to a transportation provider, such as a transportation provider A 120A. At block 610, the transportation provider A 120A may log into the system 200. The transportation provider A 120A may log into the system 200 via the same methods elaborated above for the user A 110A. Once the transportation provider A 120A logs into the system 200, the system 200 may move to block 620.

At block 620 the transportation provider A 120A may submit a bid for being matched with users 110A-N. The transportation provider A 120A may place a bid on all users 110A-N generally or may bid on users 110A-N being transported from an origin x, and/or users 110A-N being transported to a destination y, and/or users 110A-N being transported during a specific timeframe t. The origin x may be represented by a physical location address or by the area within a specified radius of the physical location address or may be represented by a geographic area identified by the transportation provider A 120A. The transportation provider A 120A may also submit bids in real time for users 110A-N that may be available to be transported. The transportation provider A 120A may not submit any bids and may still be matched with users 110A-N who have identified the transportation provider A 120A as their preferred transportation provider. The transportation provider A 120A may also purchase advertising which may be displayed to the users 110A-N while they are interacting with the system 200.

At block 630 the transportation provider A 120A may wait to be notified of available users 110A-N to provide transportation to. At block 635 the system 200 may determine whether a group of users 110A-N have accepted a match to the transportation provider A 120A. If no group of users 110A-N have accepted a match to the transportation provider A 120A, the system 200 may proceed to block 630 and the transportation provider A 120A may continue to wait to be notified of available users 110A-N. If a group of users 110A-N have accepted a match to the transportation provider A 120A, the system 200 may move to block 640 where the transportation provider A 120A may receive notification of being matched to users 110A-N at the origin x and the date/time z. The transportation provider A 120A may be notified of the match to the users 110A-N via any of the modes mentioned above for user notification, such as through email or a text message.

Alternatively the, the transportation provider A 120A may have the option to decide whether or not to provide transportation to the users 110A-N. The transportation provider A 120A may analyze the users 110A-N reputation values and any other values associated with the users 110A-N characteristics in making this determination. For instance, if the transportation provider A 120A values high tips, and the users 110A-N tipping reputation value is low, the transportation provider A 120A may not chose to accept the users 110A-N. Alternatively or in addition, the transportation provider may be bound to transporting the users 110A-N if they had previously bid on the users 110A-N. If the transportation provider A 120A decides not to accept the users 110A-N, the system 200 may move back to block 630 where the transportation provider A 120A may wait for notification of available users 110A-N.

At block 650, the transportation provider A 120A may be given the option to print out a placard that contains information capable of identifying the users 110A-N they may choose to provide transportation to. The system 200 may supply a placard that the transportation provider A 120A can print. The system 200 may then move to blocks 655, 660 and 665. At block 655, the system 200 may determine whether any of the users 110A-N have exceeded their cancellation threshold. The users 110A-N cancellation thresholds can be exceeded by any of the aforementioned events, such as the user A 110A cancelling the transportation share or delays in the user A 110A travels.

If any of the users 110A-N cancellation thresholds have been exceeded the system 200 may move to block 675, where the system 200 may determine whether, after breaching the user cancellation threshold, two or more users 110A-N remain matched to the transportation provider A 120A. If there are still two or more users 110A-N matched to the transportation provider A 120A, the system 200 may move to block 660. If there are less than two users matched to the transportation provider A 120A after a user cancellation threshold is exceeded, the system 200 may move to block 680. At block 680, the system 200 may notify the transportation provider A 120A that the transportation share has been cancelled. The system 200 may then proceed to block 630 where the transportation provider A 120A waits to be matched to users 110A-N.

At block 660, the system 200 may determine whether the transportation provider A 120A cancellation threshold has been exceeded. The transportation provider A 120A cancellation threshold may be exceeded by various events, such as the transportation provider A 120A cancelling the transportation. If the transportation provider A 120A cancellation threshold is exceeded, the system 200 may move to block 630 where the transportation provider A 120A waits to be matched to users 110A-N.

If the transportation provider A 120A cancellation threshold was not exceeded, the system 200 may move to block 665. At block 665 the system 200 may determine whether the current time equals or surpasses the date/time z, the date/time when the transportation provider A 120A is to provide transportation to the users 110A-N. If the date/time z has not arrived, the system 200 may move to block 655 and may continue to check for cancellation threshold exceeds. If the current date/time is equal to or has surpassed the date/time z, the system 200 may move to block 670.

At block 670, the transportation provider A 120A may interact with the users 110A-N at the origin x and date/time z. The transportation provider A 120A may use the aforementioned placard to assist in interacting with the users 110A-N. The interaction with the users 110A-N may include transporting the users 110A-N to their destinations. After the transportation provider A 120A has interacted with the users 110A-N, the system 200 may move to block 685. At block 685, the transportation provider A 120A may rate the users 110A-N based on the transportation provider A 120A experience with the users 110A-N. The transportation provider A 120A may rate any characteristic of a user A 110A that may be helpful in establishing the user A 110A reputation, such as the user A 110A friendliness, punctuality, hygiene, obnoxiousness, tipping, or any other characteristic that may assist the transportation providers 120A-N in determining whether to provide transportation to the user A 110A.

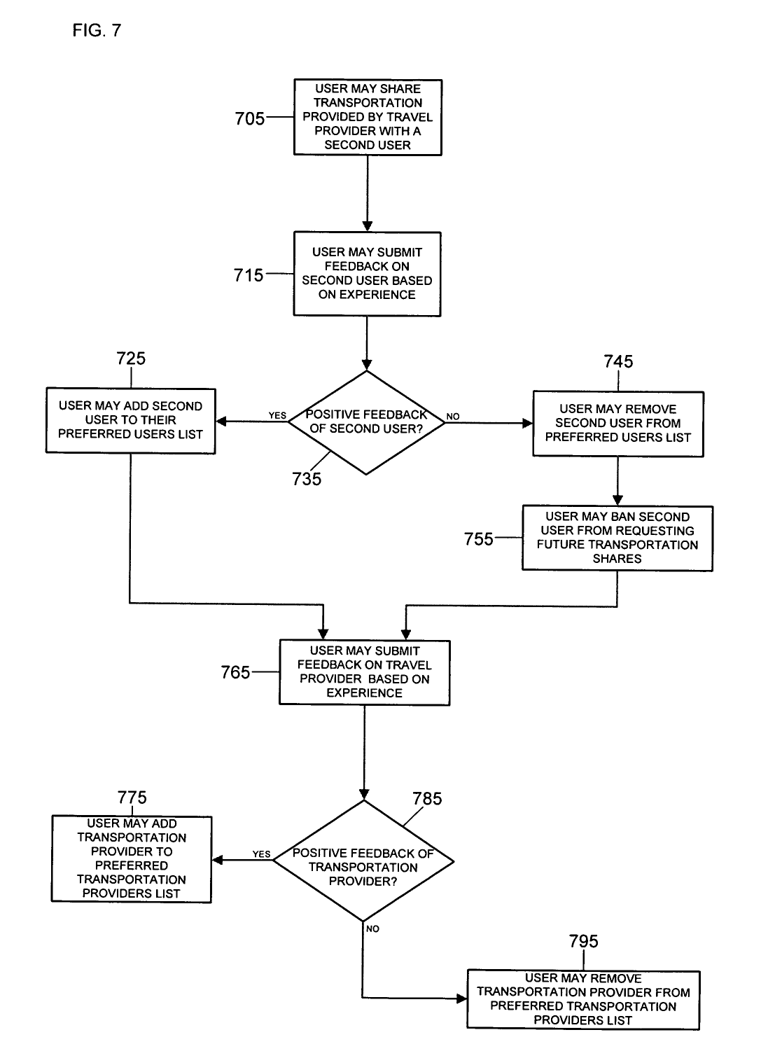

FIG. 7 is a flowchart illustrating operations of rating, or giving feedback to, a user and a transportation provider such as, in the system 200 for matching a first user to a second user and then matching both users to a transportation provider. At block 705 the user A 110A may share transportation with a second user B 110B provided by transportation provider A 120A. The remaining steps may apply to both the user A 110A and the user B 110B, however, for readability the steps solely reference the user A 110A perspective.

The system 200 may move to block 715, where the user A 110A may submit feedback on the user B 110B based on their transportation sharing experience. The user A 110A may give the user B 110B an overall reputation rating and may rate the user B 110B based on any category that may be helpful for future users 110A-N in deciding whether to share transportation with the user B 110B, such as, friendliness, hygiene, or punctuality. The system 200 may then move to block 735, where the system 200 may determine whether the user A 110A gave positive feedback to the user B 110B. If the user A 110A gave positive feedback to the user B 110B, the system 200 may move to block 725. At block 725 the user A 110A may add the user B 110B to their preferred users list. Alternatively or in addition, the system 200 may automatically add the user B 110B to the user A 110A preferred user list if the user A 110A feedback of the user B 110B surpasses a positive feedback threshold. The system 200 may have a default positive feedback threshold or the user A 110A may be given the opportunity to set a positive feedback threshold in their user preferences. The system 200 may then move to block 765.

If the user A 110A gave negative feedback to the user B 110B in block 735, the system 200 may move to block 745. At block 745 if the user B 110B is on the user A 110A preferred users list the user A 110A may remove the user B 110B from their preferred users list. Alternatively or in addition, if the user B 110B is on the user A 110A preferred users list, the system 200 may automatically remove the user B 110B from the user A 110A preferred users list if the user A 110A feedback of the user B 110B exceeds a negative feedback threshold. The system 200 may have a default negative feedback threshold or the user A 110A may be given the opportunity to set a negative feedback threshold in their user preferences. The system 200 may move to block 755 where the user A 110A may be given the option to ban the user B 110B from requesting any future transportation sharing with the user A 110A.

Alternatively or in addition, the system 200 may automatically ban the user B 110B from requesting any future transportation shares with the user A 110A if the value of the user A 110A negative feedback exceeded the user A 110A ban threshold. The system 200 may have a default ban threshold or the user A 110A may be given the option to set their ban threshold in their user preferences. The system 200 may then proceed to block 765.

At block 765, the user A 110A may submit feedback on the transportation provider A 120A based on the user A 110A experience with the transportation provider A 120A in block 705. The system 200 may then proceed to block 785, where the system 200 may determine whether the user A 110A gave positive feedback to the transportation provider A 120A. If the user A 110A gave positive feedback to the transportation provider A 120A, the system 200 may move to block 775. At block 775, the system 200 may give the user A 110A the option to add the transportation provider A 120A to the user A 110A list of preferred transportation providers. Alternatively or in addition, the system 200 may automatically add the transportation provider A 120A to the user A 110A list of preferred transportation providers if the user A 110A feedback of transportation provider A 120A surpasses a transportation provider positive feedback threshold. The system 200 may set a default transportation provider positive feedback threshold, or the user A 110A may be given the option to set a transportation provider positive feedback threshold in their user preferences.

If the user A 110A did not give positive feedback to the transportation provider A 120A, the system 200 may move to block 795. At block 795, if the transportation provider A 120A is on the user A 110A list of preferred transportation providers, the system 200 may give the user A 110A the opportunity to remove the transportation provider A 120A from the user A 110A list of preferred transportation providers. Alternatively or in addition, if the transportation provider A 120A is on the user A 110A list of preferred transportation providers, the system 200 may automatically remove the transportation provider A 120A from the list of preferred transportation providers if the user A 110A feedback of the transportation provider A 120A exceeded the transportation provider negative feedback threshold. The system 200 may have a default transportation provider negative feedback threshold or the user A 110A may have the ability to set the default transportation provider negative feedback threshold in their user preferences.

The user A 110A may also have the opportunity to ban the transportation provider A 120A from providing transportation to the user A 110A in the future. Alternatively or in addition, the system 200 may automatically ban the transportation provider A 120A from providing transportation to the user A 110A in the future if the user A 110A feedback of the transportation provider A 120A exceeds the user A 110A transportation provider ban threshold. The system 200 may have a default value for the transportation provider ban threshold or the user A 110A may have the ability to set the transportation provider ban threshold in their user preferences.

There may be many different modes in which transportation providers 120A-N and users 110A-N may interact with the system 200. The users 110A-N may log into the system 200 through a web application 210A several days in advance of the date/time z, and may make themselves available to share transportation or may search for users 110A-N available to share transportation. Alternatively or in addition, the user A 110A may log into the system 200 through a mobile application 210N or a web application 210A minutes before they wish to share transportation. The system 200 may supply real time information of users 110A-N who may be available to share transportation at the current location of the user A 110A If the users 110A-N devices have GPS, the system 200 may also supply the GPS information to each user for locating the other users 110A-N and the transportation provider A 120A. The system 200 may be in constant communication with a user A 110A who accesses the system 200 through a mobile application 110N running on a mobile device.

For instance, if a user A 110A disembarked from a flight, they may be able to immediately access the system 200 from their mobile device or laptop computer and request to be matched to a second user B 110B to share transportation immediately at origin x. In this case, the system 200 may communicate directly to the user A 110A through a standalone application 210B running on the user A 110A device, or through text messages, emails, or messaging applications, such as YAHOO! MESSENGER. If the system 200 finds a match for the user A 110A, the system 200 may immediately notify the user A 110A of the match. This may allow users 110A-N to interact in real time ensuring their transportation share may not be affected by delays. The system 200 may act as a broker between users 110A-N, giving them the ability to share transportation and the security associated with the user reputation values and the personal information supplied to the system 200 by the users 110A-N.

The transportation providers 120A-N may also access the system 200 several days in advance of date/time z, or in real time. The transportation providers 120A-N who interact with the system 200 in real time may be in constant data communication with the system 200. In this instance, the system 200 may communicate directly to a transportation provider A 120A through a standalone application 210B running on the transportation provider device, or through text messages, emails, or messaging applications, such as YAHOO! MESSENGER. In the case of real-time user interaction, the transportation providers 120A-N may supply the system 200 with the GPS coordinates of their available transportation. Since a real-time user interaction may require that a transportation provider A 120A have available transportation near the users 110A-N, the system 200 may factor the proximity of the transportation providers 120A-N transportation when matching the users 110A-N to a transportation provider A 120A.

The system 200 may supply a transportation provider A 120A with the GPS coordinates of the location of the users 110A-N to assist in meeting the users 110A-N at the origin x and the date/time z. The system 200 may also supply the users 110A-N with the GPS coordinates of the location of the transportation being provided by a transportation provider A 120A. The application running on the users 110A-N mobile device or laptop may assist the users 110A-N in meeting a transportation provider A 120A at the origin x and date/time z. The reputation values of the users 110A-N and the transportation providers 120A-N and the personal information supplied by the users 110A-N and transportation providers 120A-N provide security to both the users 110A-N and the transportation providers 120A-N in having their GPS coordinates provided to the other parties. A user A 110A or a transportation provider A 120A may have the option of preventing their location from being revealed.

The above referenced illustrations demonstrate the operations of the system 200 when matching two users together. Alternatively or in addition, the system 200 may match several users 110A-N to a transportation provider A 120A. The system 200 may have a set maximum number of users 110A-N or the individual users 110A-N may specify the maximum number of users 110A-N they wish to share transportation with. If the transportation share has not surpassed the maximum number of users 110A-N specified by the user A 110A, the system 200 may continue to match users 110A-N to the user A 110A.

In this instance, the transportation providers 120A-N may be required to provide the maximum number of passengers their transportation can transport. The maximum number of passengers may be factored into selecting a transportation provider A 120A to match to the users 110A-N. If users 110A-N are matched to a transportation provider A 120A and additional users 110A-N are subsequently added, causing the number of users 110A-N to surpass the transportation provider A 120A maximum number of passengers, the transportation provider A 120A cancellation threshold may be exceeded. If the transportation provider A 120A cancellation threshold is exceeded, the system 200 may attempt to determine an alternate transportation provider B 120B to match with the users 110A-N.

The illustrations of the embodiments described herein are intended to provide a general understanding of the structure of the various embodiments. The illustrations are not intended to serve as a complete description of all of the elements and features of apparatus and processors that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method for matching one or more users and a transportation provider comprising:
identifying a first user in need of transportation;
identifying a second user in need of transportation;
identifying a transportation provider available to provide transportation;
matching with a matching service the first user and the second user to create a matched group; and
matching with the matching service the matched group to the transportation provider.

2. The method of claim 1 further comprising: notifying the first user, the second user and the transportation provider that they have been matched.

3. The method of claim 1 further comprising:
tracking a user reputation value.

4. The method of claim 3 wherein the user reputation value is based on an opinion of at least one of the first user and the second user.

5. The method of claim 3 further comprising:
maintaining an overall user reputation value based on the user reputation value of each successive matching.

6. The method of claim 5 wherein the matching with a matching service of the first user and the second user to create a matched group is based on overall the user reputation value.

7. The method of claim 1 further comprising:
tracking a transportation provider reputation value.

8. The method of claim 7 wherein the transportation provider reputation value is based on the opinions of at least one of the first user and second user.

9. The method of claim 7 further comprising:
maintaining an overall transportation provider reputation value based on the transportation provider reputation value of each successive matching.

10. The method of claim 9 wherein the matching with a matching service of the transportation provider to the matched group is based on the overall transportation provider reputation value.

11. The method of claim 1 wherein the transportation provider is a taxi cab provider.

12. The method of claim 1 wherein the first user and the second user have supplied identifying information.

13. The method of claim 1 wherein the transportation provider has supplied identifying information.

14. A system for matching one or more users and a transportation provider comprising:
a memory able to store information capable of identifying a transportation provider, a first user and a second user;
an interface operatively connected to the memory, which the system uses to interact with the transportation provider, the first user and the second user; and
a processor operatively connected to the memory, and the interface, which identifies the first user, identifies the second user, identifies the transportation provider, matches the first user and the second user to create a matched group, and matches the matched group to the transportation provider.

15. The system of claim 14 wherein the processor notifies the first user, the second user, and the transportation provider that they have been matched.

16. (canceled)

17. (canceled)

18. The system of claim 16 wherein the processor matches the first user and the second user to create a matched group based on the user reputation value.

19. (canceled)

20. (canceled)

21. (canceled)

22. The system of claim 14 wherein the transportation provider is a taxi cab provider.

23. A method for matching one or more users for sharing transportation comprising:
identifying a first user in need of transportation;
identifying a second user in need of transportation;
identifying a transportation provider available to provide transportation;
matching the first user, the second user and the transportation provider based on a reputation value.

24. The method of claim 23 wherein the reputation value is based on the opinions of at least one of the first user and the second user.

25. The method of claim 23 wherein the reputation value will decrease if at least one of the first user and the second user fails to properly share transportation.

26. The method of claim 23 wherein the reputation value will increase if at least one of the first user and the second user properly share transportation.

27. The method of claim 23 wherein the reputation value will decrease if the transportation provider fails to properly provide transportation.

28. The method of claim 23 wherein the reputation value will increase if the transportation provider properly provides transportation.

29. The method of claim 23 wherein the transportation provider comprises a taxi cab provider.

30. The method of claim 23 wherein at least one of the first user and the second user have supplied identifying personal information.
